(19) United States
(12) Patent Application Publication
(10) Pub. No.: US 2007/0028427 A1
(43) Pub. Date: Feb. 8, 2007

(54) Loop clamp

(75) Inventors: Giovanni C. Albini, Watertown, CT (US); Kevin Joseph Audibert, Wolcott, CT (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 11/197,097

(22) Filed: Aug. 4, 2005

(51) Int. Cl. F16L 33/00

(52) U.S. Cl. 24/20 R

(57) ABSTRACT

A continuous loop clamp includes an endless loop shaped body providing a central opening in which a device for clamping is positionable. The body includes a continuous interior surface defining the opening and an exterior surface. The entire continuous interior surface contacts the device when the clamp is applied. The clamp also includes an aperture defined in the body from the interior surface to the exterior surface. The device is inserted into the opening along an axis and the body can be deformed at the aperture to decrease the size of the opening. No portion of the body substantially projects radially outwardly of the exterior surface, either before the body is deformed or after the body is deformed.

### FIELD OF THE INVENTION

The present invention generally relates to clamps, and more particularly to loop clamps.

### BACKGROUND OF THE INVENTION

Numerous types of clamps exist in the market place and are capable of clamping a variety of devices such as hoses, tubes, shafts, rods, axles, etc. One particular type of clamp is a loop clamp, which comes in a variety of shapes, sizes and types. Loop clamps generally include a flat thin body having two ends. The body is bendable to form a loop around a device and then the two ends are connected to tighten and secure the clamp around the device. A variety of manners exist for connecting the two ends of the body. For example, the ends can include a buckle-type connection or a T-lock connection.

With respect to buckle-type connections, the two ends of the body are commonly overlapped and a projection on one end of the body inserts into one of many apertures defined in the other end of the body. The numerous apertures provide the clamp with adjustability to clamp a variety of different sized devices. The end of the body including the projection usually has a portion that drastically projects radially outwardly from the body to make the body bulky, thereby providing a potential obstruction to surrounding components. Overlapping ends also create a potential weak point in the seal between the clamp and the device. Such a weak point often occurs at the location where the upper end overlapping the lower end elevates away from the device to clear the lower end, thereby providing a location where the interior surface of the clamp is spaced from the device.

Regarding T-lock connections, one end of the body commonly includes a receptacle and the other end includes a projection (usually in the shape of a “T”) extending substantially co-planar with the body. Rather than the two ends overlapping, the two ends meet each other and the projection inserts into the receptacle to connect the two ends of the body, thereby providing a clamp with a relatively low profile. Clamps having a T-lock connection are not adjustable and, therefore, can only accommodate a single sized device. The lack of adjustability limits the uses of the clamp and creates the possibility of an ineffective seal. Such ineffective seals are usually formed by cinching the clamp around the device to connect the ends thereof, then, when the clamp is released, the clamp increases in size until the projection bottoms-out in the receptacle. If the clamp increases in size too much, an ineffective seal may result.

### BRIEF SUMMARY

In view of the foregoing, a clamp is needed that has a low profile, is adjustable and creates an effective seal between the clamp and devices to be clamped.

In some aspects, a continuous loop clamp is provided and includes an endless loop shaped body providing a central opening in which a device for clamping is positionable. The body includes a continuous interior surface defining the opening and an exterior surface. The entire continuous interior surface contacts the device when the clamp is applied.

The continuous loop clamp may also include an aperture defined through the body from the interior surface to the exterior surface. The body may be deformed at the aperture to decrease the size of the central opening. The device may be inserted into the opening along an axis and the body may be deformed at the aperture in a direction substantially parallel to the axis to decrease the size of the opening.

In other aspects, a clamp is provided and includes a body having a loop shape to provide a central opening in which a device for clamping is positionable. The body includes an interior surface defining the opening and an exterior surface. An aperture is defined through the body from the interior surface to the exterior surface and the body can be deformed at the aperture to decrease the size of the opening.

In further aspects, a method of clamping is provided and includes providing a clamp having a loop shaped body, the body including an interior surface defining an opening, an exterior surface, and an aperture defined through the body from the interior surface to the exterior surface. The method also includes inserting a device to be clamped into the opening along an axis and deforming the body at the aperture to decrease the size of the opening around the device.

Other features and advantages of the invention will become apparent to those skilled in the art upon review of the following detailed description, claims, and drawings.

### BRIEF DESCRIPTION OF THE DRAWINGS

FIG. 1 is a perspective view of a continuous loop clamp, shown in an uncrimped condition.

FIG. 2 is a perspective view of the clamp shown in FIG. 1, shown in a crimped condition.

FIG. 3 is a perspective view of the clamp shown in FIG. 1 and an application of the clamp.

FIG. 4 is a top view of the clamp shown in FIG. 1, shown in the uncrimped condition and having a first inner diameter.

FIG. 5 is a top view of the clamp shown in FIG. 1, shown in a crimped condition and having a second inner diameter.

FIG. 6 is a perspective view of the clamp shown in FIG. 1, shown with the apertures deformed in an alternate manner to that shown in FIG. 2.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways.

### DETAILED DESCRIPTION

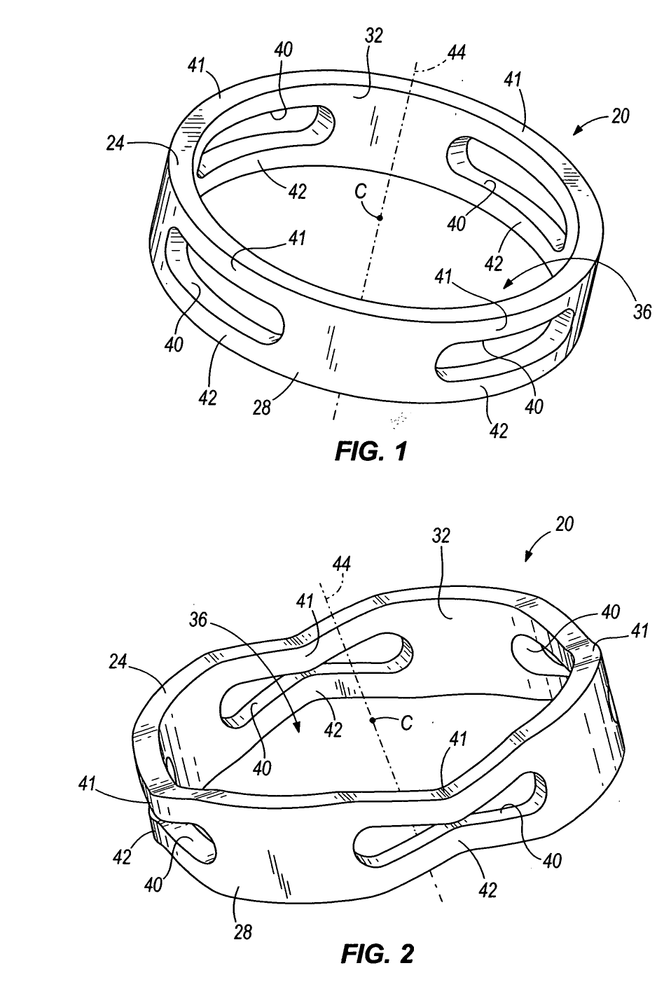

Referring to FIG. 1, a continuous loop clamp 20 is illustrated. In the illustrated embodiment, the clamp 20 is made of a suitable metal. The clamp 20 includes a main body 24 having an endless loop shape. In the illustrated embodiment, the clamp 20 has a substantially circular loop shape. Alternatively, the clamp 20 can have other loop shapes such as, for example, oval, square, rectangular, triangular, etc. The body 24 can be formed into the endless loop shape in a variety of manners. For example, the body 24 can be machined and cut from tube stock. Alternatively, the body 24 can be stamped from a flat piece of sheet stock, rolled into a loop shape with the two ends engaging, and the two ends can be welded, brazed or otherwise appropriately bonded to form an endless loop.

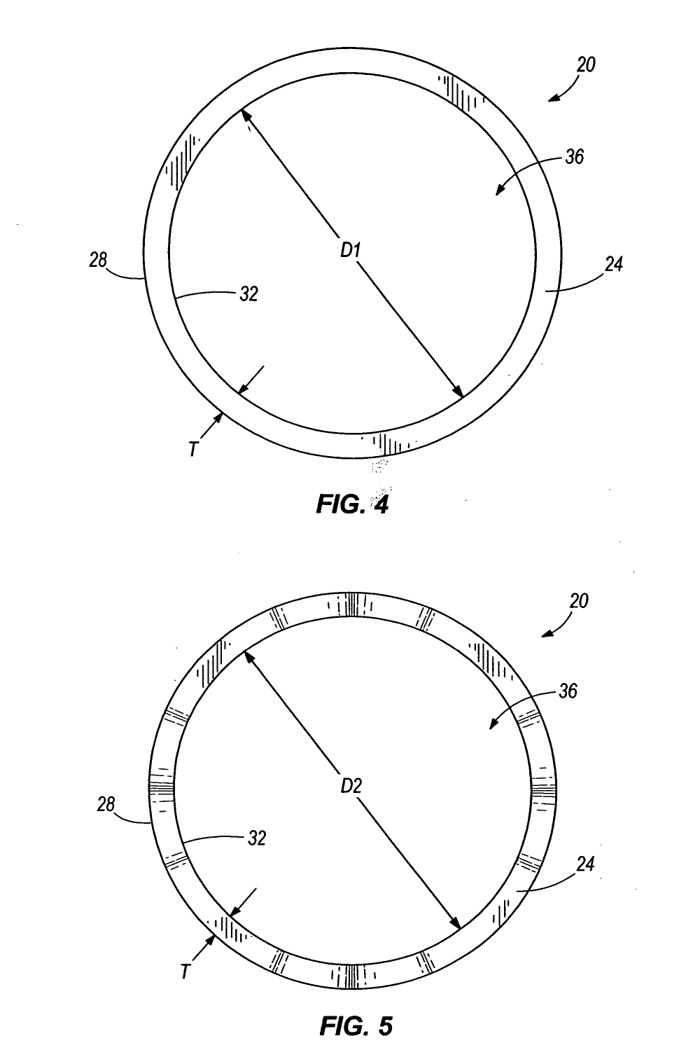

The body 24 includes an exterior surface 28 and an interior surface 32 that defines an opening 36 through the body 24. In the illustrated embodiment, the interior surface 32 is continuous and does not have any breaks due to the endless loop shape of the body. The body 24 also has a relatively thin profile (i.e., the thickness of the body 24 between the exterior surface 28 and the interior surface 32). Also in the illustrated embodiment, the body 24 has a substantially constant thickness T (see FIGS. 4 and 5), and no portion of the clamp 20 protrudes radially outwardly from the generally cylindrical footprint or envelope defined by the exterior surface 28. Any such protrusions extending radially outwardly from the generally cylindrical footprint or envelope defined by the exterior surface 28 could obstruct or interfere with surrounding devices or parts.

A plurality of apertures 40 (the purpose of which will be described below) are defined through the main body 24, providing first and second spaced-apart body portions 41 and 42, respectively, positioned on opposite sides of the apertures 40. In the illustrated embodiment, four apertures 40 are defined in the main body 24 and each aperture 40 has an elongated, oval shape. Alternatively, the clamp 20 can include any number of apertures 40 and the apertures 40 can assume any appropriate shape.

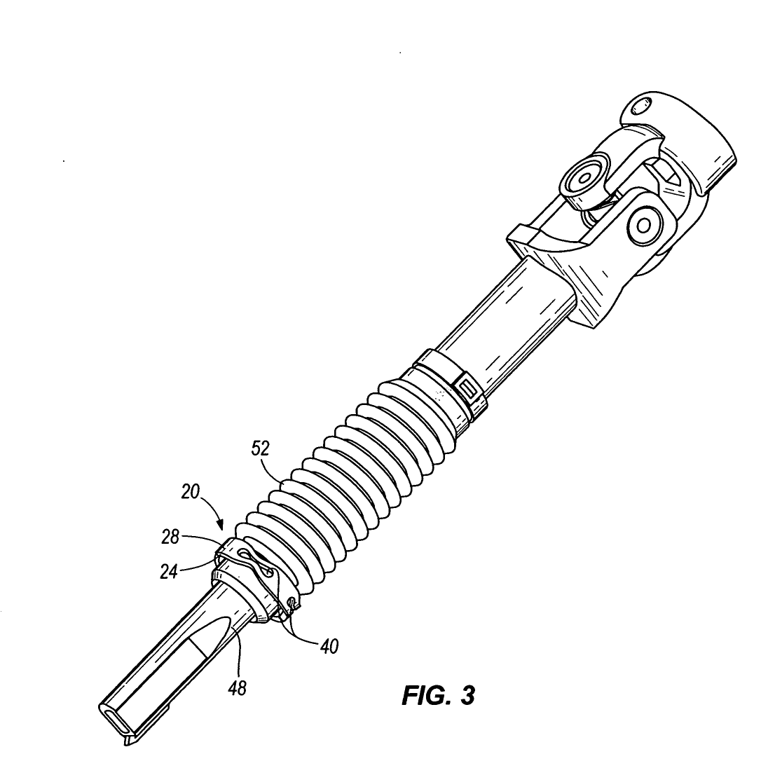

With reference to FIGS. 1, 2, 4 and 5, the adjustability or tightening of the clamp 20 will be discussed. FIGS. 1 and 4 illustrate the clamp 20 in a non-deformed or uncrimped condition, in which the clamp 20 has a first inner diameter D1 defined by the interior surface 32 of the clamp 20. To tighten the clamp 20 around a device, otherwise known as clamping, a user positions a tool, such as a pliers or the like, adjacent the first and second body portions 41, 42, respectively, at a location in alignment with one of the apertures 40. Then using the tool, the user applies a force to deform or crimp the first and second body portions 41, 42 together as shown in FIG. 2. The forces causing the crimping are generally applied in a direction substantially parallel to an axis 44, which extends through a center C of the opening 36. The axis 44 is also an insertion axis along which a device to be clamped is inserted into the opening 36, as will be discussed further below. Crimping or squeezing together the body portions 41, 42 in such a manner decreases the inner diameter of the clamp 20. FIGS. 2 and 5 illustrate the clamp 20 in a crimped condition, in which the body 24 is crimped at all four apertures 40 and the clamp 20 has a second inner diameter D2 that is smaller than the first inner diameter D1.

Providing numerous apertures 40 allows for greater adjustability and increases the extent to which the inner diameter can be decreased. A user can select the appropriate number of crimps to make in the body 24 depending on the application and size of the device to be clamped. In other words, the body 24 can be crimped at any number of the apertures 40.

It should be understood that clamps 20 having shapes other than circular, as is illustrated in the figures, operate in a similar manner to that previously described. However, identifying the dimensions of the opening 36 defined by the interior surface 32 by diameter may not be appropriate (as in the case of rectangular, triangular, square, and other shaped clamps). Therefore, the dimensions of the interior surface 32 may be represented in different manners such as, for example, length and width. Accordingly, in such cases, the length and/or width would be decreased by crimping the body 24 at location(s) of the aperture(s) 40.

It should also be understood that the body 24 can be crimped to varying extents. For example, the body 24 can be crimped completely such that the body portions 41 and 42 contact one another, or slightly crimped such that the body portions 41 and 42 are barely deformed from their uncrimped condition. This feature, combined with the clamp 20 having numerous apertures 40, provides a user with great flexibility for properly clamping a device and provides great flexibility for accommodating and clamping devices having a large variety of sizes.

It should further be understood that the apertures 40 can be appropriately sized and shaped to accommodate more than one crimp. For example, the aperture 40 may extend around the body 24 a greater distance and allow a user to perform two or three adjacent crimps at the same aperture 40.

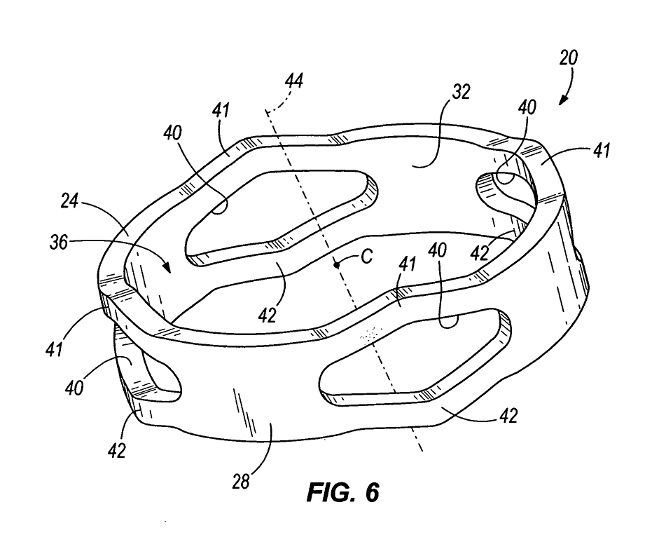

Those skilled in the art will also understand that the inner diameter of the clamp 20 could be reduced in size by spreading the first and second body portions 41, 42 apart from one another in a direction generally parallel to the axis 44, as is shown in FIG. 6. For example, a tool could be inserted into an aperture 40 and actuated (e.g., by spreading two members apart, by rotating the tool, etc.) to cause the first and second body portions 41, 42 to spread apart. Therefore, just as the clamp 20 can be deformed at the apertures 40 by crimping the body portions 41, 42 together as shown in FIG. 2, the clamp 20 can also be deformed by spreading the body portions 41, 42 apart as shown in FIG. 6.

Now that the clamp 20 and manners of deforming the body 24 of the clamp 20 have been described, a manner of clamping the clamp 20 to a device will be described with reference to FIG. 3. In the illustrated embodiment, the clamp 20 will be used to clamp together a steering intermediate shaft 48 and a boot 52. However, the clamp 20 can be used to clamp a variety of devices together in a variety of applications and is not limited to steering linkage assembly applications. To perform the clamping operation, the clamp 20 is slid over the shaft 48 and boot 52 by aligning them with the opening 36 and sliding them through the opening 36 to position the clamp 20 at the location where clamping is required. In the present example, the clamp 20 is aligned with an end of the boot 52. Once the clamp 20 is in position, a user utilizes a tool (e.g., a pliers or the like as discussed above) to crimp the body 24 at a location of one of the apertures 40. The user continues to crimp the body 24 the appropriate amount and at the appropriate number of apertures 40 to effectively clamp 20 the devices together. By crimping or squeezing the clamp 20 in this manner, no portion of the clamp projects radially outwardly from the exterior surface, thus, there is no space restrictions created by the clamp 20 in the surrounding area. Additionally, as shown in FIG. 3, substantially the entire continuous interior surface 32 of the clamp 20 contacts the surface of the shaft 48 and/or boot 52 when the clamp 20 is applied. Again, instead of crimping at the apertures 40, the body portions 41, 42 could alternatively be spread apart in the manner shown in FIG. 6 to obtain the desired clamping.

Embodiments of the invention have been described above to better communicate the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A continuous loop clamp comprising: an endless loop shaped body providing a central opening in which a device for clamping is positionable, the body including a continuous interior surface defining the opening and an exterior surface, the entire continuous interior surface contacting the device when the clamp is applied.

2. The continuous loop clamp of claim 1, further comprising an aperture defined through the body from the interior surface to the exterior surface.

3. The continuous loop clamp of claim 2, wherein the body is deformed at the aperture to decrease the size of the opening.

4. The continuous loop clamp of claim 2, wherein the device is insertable into the opening along an axis, and wherein the body is deformed at the aperture in a direction substantially parallel to the axis to decrease the size of the opening.

5. The continuous loop clamp of claim 1, further comprising at least two apertures defined through the body from the interior surface to the exterior surface, and wherein the body is deformed at any of the apertures to decrease the size of the opening.

6. The continuous loop clamp of claim 1, wherein the body has a substantially constant thickness.

7. The continuous loop clamp of claim 1, wherein the device is part of a vehicle steering linkage assembly.

8. A clamp comprising:
a body having a loop shape to provide a central opening in which a device for clamping is positionable, the body including an interior surface defining the opening and an exterior surface; and
an aperture defined through the body from the interior surface to the exterior surface;
wherein the body is deformed at the aperture to decrease the size of the opening.

9. The clamp of claim 8, wherein the device is insertable into the opening along an axis, and wherein the body is deformed at the aperture in a direction substantially parallel to the axis to decrease the size of the opening.

10. The clamp of claim 8, wherein the body includes a first body portion positioned adjacent the aperture and a second body portion spaced from the first body portion by the aperture, and wherein the first and second body portions move toward one another when the body is deformed at the aperture.

11. The clamp of claim 8, wherein the body includes a first body portion positioned adjacent the aperture and a second body portion spaced from the first body portion by the aperture, and wherein the first and second body portions move away from one another when the body is deformed at the aperture.

12. The clamp of claim 8, wherein the aperture is one of at least two apertures spaced apart from one another and defined through the body from the interior surface to the exterior surface, and wherein the body is deformed at any of the apertures.

13. The clamp of claim 8, wherein the body has an endless loop shape.

14. The clamp of claim 8, wherein the device is part of a vehicle steering linkage assembly.

15. The clamp of claim 8, wherein the body has a substantially constant thickness.

16. The clamp of claim 8, wherein substantially no portion of the clamp projects radially outwardly of the exterior surface.

17. The clamp of claim 8, wherein the exterior surface of the body has a substantially smooth cylindrical shape both before the body is deformed and after the body is deformed.

18. A method of clamping comprising:
providing a clamp having a loop shaped body, the body including an interior surface defining an opening, an exterior surface, and an aperture defined through the body from the interior surface to the exterior surface;
inserting a device to be clamped into the opening along an axis; and
deforming the body at the aperture to decrease the size of the opening around the device.

19. The method of claim 18, wherein providing a clamp further includes providing a clamp having an endless loop shaped body.

20. The method of claim 18, wherein deforming the body further includes deforming the body at the aperture in a direction substantially parallel to the axis to decrease the size of the opening.

21. The method of claim 18, wherein providing a clamp further includes providing a clamp having at least two apertures defined through the body from the interior surface to the exterior surface, and wherein deforming the body further includes deforming the body at any one of the apertures to decrease the size of the opening around the device.

22. The method of claim 18, wherein the body includes a first body portion positioned adjacent the aperture and a second body portion spaced from the first body portion by the aperture, and wherein deforming the body includes moving the first and second body portions toward one another.

23. The method of claim 18, wherein the body includes a first body portion positioned adjacent the aperture and a second body portion spaced from the first body portion by the aperture, and wherein deforming the body includes moving the first and second body portions away from one another.

24. The method of claim 18, wherein the device is part of a vehicle steering linkage assembly.
